(19) United States
(12) Patent Application Publication
(10) Pub. No.: US 2024/0417175 A1
(43) Pub. Date: Dec. 19, 2024

(54) SYSTEM AND METHOD FOR PRE-SORTING IN ORDER FULFILLMENT FACILITIES

(71) Applicant: Dematic Corp., Grand Rapids, MI (US)

(72) Inventors: Arturo Hinojosa, Austin, TX (US); Ozge C. Sayilar, Austin, TX (US)

(21) Appl. No.: 18/743,393

(22) Filed: Jun. 14, 2024

Related U.S. Application Data
(60) Provisional application No. 63/508,755, filed on Jun. 16, 2023.

(51) Int. Cl. B65G 1/137; B07C 3/02; B65G 1/04

(52) U.S. Cl. CPC B65G 1/1375; B07C 3/02; B65G 1/0492; B65G 2201/0258

(57) ABSTRACT

A material handling system for retrieving, transporting, and delivering inventory totes for order fulfillment activities within a material handling facility, includes unit sortation fields, a storage area, a shuttle system with shuttles, and a control system. The unit sortation fields are arranged within the material handling facility, each for sorting inventory items for order fulfillment, with each inventory item required by an order. The storage area stores inventory totes, each containing inventory items. Each of the shuttles retrieves an inventory tote from the storage area for delivery to a selected unit sortation field of the unit sortation fields. The control system controls the order fulfillment activities within the material handling facility. The control system selects a unit sortation field from the unit sortation fields based upon the order fulfillment operations underway within ones of the unit sortation fields.

### FIELD OF THE INVENTION

The present application claims the priority benefits of U.S. provisional application, Ser. No. 63/508,755, filed Jun. 16, 2023, which is hereby incorporated herein by reference in its entirety.

The present invention is directed to warehouse automation and, in particular, pre-sorting activities for inventory/material throughout a warehouse. While the invention is illustrated for use with autonomous mobile robot (AMR) based systems it should be understood that this term broadly includes automated mobile vehicles, i.e., automated guided vehicles (AGV), drones, humanoid robots, quadruped, etc.

### BACKGROUND OF THE INVENTION

E-commerce retail and changing demand patterns are driving increased variation in the types and formats of products (e.g., single-count versus multi-count) handled in goods distribution centers. Distribution centers not only need to deal with increased product variety, but also volatile and unpredictable shifts in demand patterns which are typically mitigated by buffer storage of a large variety of unit categories. In addition to increased storage demands, efficient order fulfillment requires proper sorting of inventory items for, and during, order fulfillment. Such unit sortation processes and systems are widely used in high-capacity order fulfillment system for E-commerce orders, store replenishment orders, and omnichannel applications. Unit sortation also allows for the processing of orders with very short cycle times.

### SUMMARY OF THE INVENTION

The present invention provides an automated warehouse material handling and movement system, method, and non-transitory computer readable medium of handling or moving material within a warehouse or material handling facility. The system, method, and non-transitory computer readable medium include a process for optimized pre-sorting using one or more optimization processes. Such pre-sorting optimizations include, for example, a process for the selection of an optimal unit sortation field to release order(s). Such a process balances the order fulfillment workload across multiple unit sortation fields. Other pre-sorting optimizations include a process for the selection of order(s) to release within a unit sortation field. Thus, optimal orders are found to activate within a specific unit sortation field. The pre-sorting optimizations include a process for the selection of inventory for the order. The “best” inventory for fulfilling the order(s) that are released are selected, which includes the reuse of active donor totes. The pre-sorting optimizations also include a process for managing the assignment of missions to shuttles, which are used for retrieval and transport missions. Thus, once the inventory allocation (and donor totes) have been selected, the process determines when to assign a retrieval mission to a shuttle carrying the selected donor tote(s). An objective is to ensure that the shuttle is fed enough retrieval missions to prevent the shuttle from being starved while also ensuring that the shuttle is not pre-committed to too many missions. Such pre-sorting processes, when carried out by exemplary order fulfillment systems, provide for a pre-sorting process without resorting to conventional sorting methods and reducing labor and cycling time.

In an aspect of the present invention, an exemplary method and fulfillment system discloses a process whereby the inventory items for an order are presorted as part of the process for delivering them to a unit sortation field for order fulfillment. An exemplary pre-sorting process (before delivery to a unit sortation field) is used with an order fulfillment system with multiple unit sortation fields. A first step in the process is a selection of a particular unit sortation field out of the multiple unit sortation fields. With the selection of a unit sortation field, the allocation of orders is optimized with respect to the selected unit sortation field. Additionally, based upon the selected orders (which may be optimized for the selected unit sortation field), optimized donor totes (with the requested inventory item SKUs for order fulfillment) are selected with respect to the selected orders and the selected unit sortation field. Lastly, the operation of shuttles within an automated storage and retrieval system (ASRS) is coordinated such that the shuttle retrieval and delivery of selected donor totes is optimized for the selected order and the selected unit sortation field.

In an aspect of the present invention, an exemplary material handling system for retrieving, transporting, and delivering inventory totes for order fulfillment activities within a material handling facility, includes a plurality of unit sortation fields, a storage area, a shuttle system including a plurality of shuttles, and a control system. The unit sortation fields are arranged within the material handling facility, each for sorting operations of inventory items for order fulfillment activities, with each inventory item required by an associated order. The storage area is configured for storing inventory totes, each comprising one or more associated inventory items. Each of the shuttles is configured to retrieve an inventory tote from the storage area for delivery to a selected unit sortation field of the plurality of unit sortation fields. The control system controls the order fulfillment activities within the material handling facility. The control system selects a unit sortation field from the plurality of unit sortation fields based upon the order fulfillment operations underway within ones of the plurality of unit sortation fields.

In a further aspect of the present invention, an exemplary method of order fulfillment for retrieving, transporting, and delivering inventory totes for order fulfillment activities within a material handling facility with a plurality of unit sortation fields includes selecting a first unit sortation field from a plurality of unit sortation fields. An order is selected from a plurality of orders for release into the selected first unit sortation field. The method also includes selecting inventory totes containing inventory items required for fulfillment of the first order. The inventory totes are stored in a storage area. Selecting inventory totes comprises reserving selected inventory totes from a plurality of inventory totes for the first order and assigning release sequences for the selected inventory totes. A location of a first inventory tote of the selected inventory totes is determined and a first shuttle of a plurality of shuttles is assigned for retrieving the first inventory tote. Lastly, the method includes, retrieving, with the first shuttle, the first inventory tote and delivering the first inventory tote to the first unit sortation field.

In another aspect of the present invention, the control system selects a unit sortation field from the plurality of unit sortation fields based upon at least one of: a quantity of consolidation totes for each unit sortation field, quantities of pending inventory tote retrievals for each unit sortation field, shuttle and storage area utilizations, and sortation equipment utilization for each unit sortation field of the plurality of unit sortation fields.

In a further aspect of the present invention, the control system selects an order from a list of orders awaiting order fulfillment for the selected unit sortation field. The control system selects an order from the list of orders based upon a priority ranking of the selected order with respect to ones of the plurality of orders. The control system generates the list of orders based upon a selection of orders ready for release within the selected unit sortation field. The control system is also able to select an order from the list of orders based upon the similarity or dissimilarity of inventory items requested by orders as compared to inventory items requested by orders already released to the selected unit sortation field.

In another aspect of the present invention, the control system is operable to select inventory items for order fulfillment requested by the selected order. The control system is operable to select an inventory tote within the storage area containing the requested inventory item. The control system is operable to select a first inventory tote containing the requested inventory item from a plurality of inventory totes each containing the requested inventory item. The control system is also operable to select the first inventory tote based upon its location within the storage area.

In a further aspect of the present invention, the control system is operable to send a retrieval task to a first shuttle of the plurality of shuttles to retrieve the first inventory tote for delivery to the selected unit sortation field. Each unit sortation field of the plurality of unit sortation fields comprises at least one inbound lift and at least one outbound lift for transporting shuttles of the plurality of shuttles between levels of the storage area, such that the first shuttle is able to retrieve the first inventory tote from anywhere within the storage area and delivery the requested inventory tote to the selected unit sortation field.

In another aspect of the present invention, the storage area is an automated storage and retrieval system. The plurality of unit sortation fields are arranged with respect to the automated storage and retrieval system.

Accordingly, methods and a system are provided for pre-sorting processes such that preselected inventory items for selected orders are delivered at selected times via preselected means to a selected unit sortation field for unit sortation activities.

These and other objects, advantages, purposes, and features of this invention will become apparent upon review of the following specification in conjunction with the drawings.

### BRIEF DESCRIPTION OF THE DRAWINGS

FIG. 1 is a block diagram illustrating the operational and control components of an exemplary order fulfillment system;

FIG. 2 is a block diagram of an exemplary aspect of a fulfillment/warehouse facility employing the control system in accordance with the present invention;

FIG. 3 is a block diagram of an exemplary arrangement of unit sortation fields of an order fulfillment system in accordance with the present invention;

FIG. 4 is a perspective view of an exemplary automated storage and retrieval system (ASRS) in accordance with the present invention;

FIGS. 5A and 5B illustrate the steps to a method for pre-sorting a selected order to be sorted in a selected unit sortation field of an order fulfillment system in accordance with the present invention;

FIG. 6 illustrates the steps to a method for selecting a unit sortation field of an order fulfillment system in accordance with the present invention;

FIG. 7 illustrates the steps to a method for selecting orders for sorting in the selected unit sortation field of FIG. 6 in accordance with the present invention;

FIG. 8 illustrates the steps to a method for selecting inventory items for fulfillment of the order selected in FIG. 7 in accordance with the present invention;

FIG. 9 illustrates the steps to a method for coordinating retrieval tasks for a selected shuttle to retrieve selected inventory items in accordance with the present invention; and

FIG. 10 illustrates a perspective view of an exemplary unit sortation field associated with an automated storage and retrieval system (ASRS) in accordance with the present invention.

### DESCRIPTION OF THE PREFERRED EMBODIMENTS

The present invention will now be described with reference to the accompanying figures, wherein numbered elements in the following written description correspond to like-numbered elements in the figures. Distribution centers not only need to deal with increased product variety, but also volatile and unpredictable shifts in demand patterns which are typically mitigated by buffer storage of a large variety of unit categories. In addition to increased storage demands, efficient order fulfillment requires proper sorting of inventory items for, and during, order fulfillment. Such sortation processes and systems are widely used in high-capacity order fulfillment systems for E-commerce orders, store replenishment orders, and omnichannel applications.

One type of sortation is unit sortation. Unit sortation-based systems offer higher flexibility to process orders than other approaches (e.g., goods-to-picker or GTP-based systems) and with less dependence on order profiles, demand forecasting, inventory multiplicity, SKU affinity, and delivery sequence to workstations. Unit sortation also allows for the processing of orders with very short cycle times. However, a limitation with very large order fulfillment facilities that utilize conventional unit sortation systems (e.g., cross-belt sorters, Bombay sorters, tilt-tray sorters, and AMR unit sorters) is the constrained capacity of single/individual sorters. Such single machine capacity can be limited to, for example, 5,000 to 20,000 sorts-per-hour depending on the type of equipment. The very large order fulfillment facilities may need to process, for example, 50,000 units per order (or more). A conventional approach to solving this capacity issue is to have multiple unit sorters in the facility with an aggregated capacity that matches the required capacity of the facility. However, a disadvantage of using multiple unit sorters in the facility is the need for consolidating an order after sortation. More specifically, in a conventional multi sorting unit, an order comprising different items (e.g., items A and B) would not necessarily be sorted at the same unit sorter. In other words, it may be that item A is sent and sorted by a unit sorter A, while item B is sent and sorted by a unit sorter B. Before shipping, the sorted items A and B would therefore need to be consolidated. Thus, the process of post-sortation consolidation (in facilities with multiple unit sorters) affects the throughput of the facility negatively.

An exemplary solution to avoiding the post-sortation consolidation process is to implement a “pre-sort process” in which items included in an order are collected and sent to the same unit sorter. Two conventional pre-sorters include manual and automated processes. An exemplary manual pre-sort process includes the creation of batch pick totes, unit sorter-pure, before the product is inducted to the sorters. The presort process can be done, for example, with totes in a pick cart used to pick product from a rack. The cart can carry several totes. In each of the totes, the picker places product to be used in one of the unit sorters. All the product in each tote must be for the unit sorter where the corresponding order will be consolidated. As these batch totes fill, they are sent (e.g., conveyed) to the corresponding unit sorter where the target orders are consolidated. An exemplary automated process includes filling batches totes in GTP stations services by multi-shuttles. Instead of pickers walking aisles to pick the items for the batch totes, the multi-shuttle sends the required donor totes to the GTP station where the picker has the batch totes for the unit sorters in the GTP put locations. At the GTP station, the picker sorts the product from the donor totes to the batch totes. After the batch tote fills, it is conveyed to the induction station of the corresponding unit sorters. While these conventional pre-sorting processes alleviate the need for post-sorting consolidation, they are problematic, as they add labor to the process, and extend the cycle time of the order processing. There is a need to improve the pre-sorting process within a multi-sorting unit order fulfillment facility.

As discussed herein, an exemplary pre-sorting process for an order fulfillment system with multiple unit sorters includes the allocation of orders optimized for selected unit sortation fields, with the selection of inventory items optimized for each selected order, as well as the coordination of shuttle retrieval and delivery of selected donor totes optimized for the selected order and associated unit sortation field.

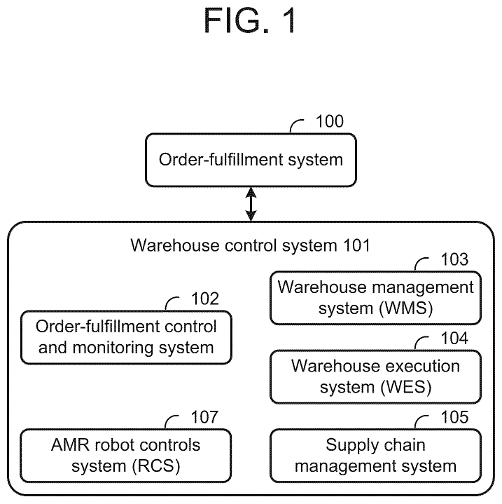

FIG. 1 illustrates an exemplary warehouse environment or aspects thereof in which order fulfillment activities are taking place. It should be appreciated that the order fulfillment systems employing control systems in accordance with the present invention may be configured and employed in numerous ways and environments utilizing variously configured and differing material storage and handling systems. Accordingly, the below discussion of FIG. 1 should be understood as non-limiting and provided for explanatory purposes.

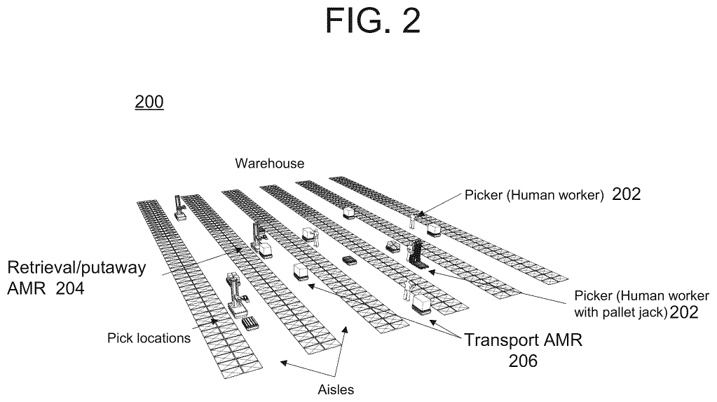

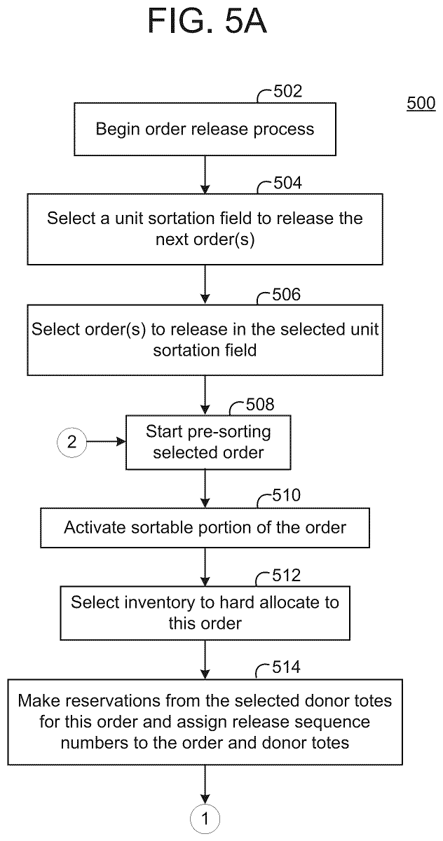

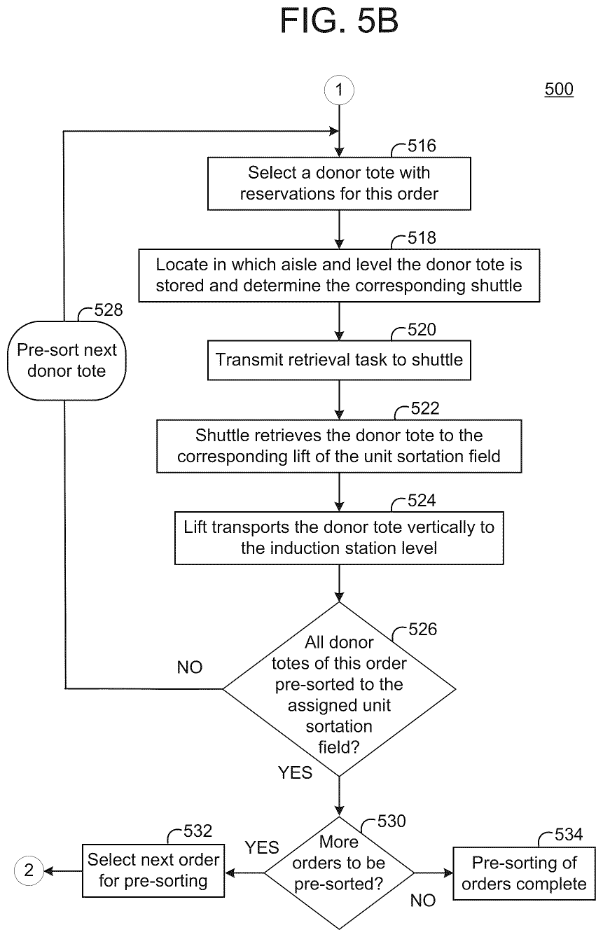

Referring to FIGS. 1 and 2, an exemplary order fulfillment system 100 includes a warehouse controller or orchestrator (a warehouse control system) 101, which can be coupled to or include a fulfillment control and monitoring system 102, a warehouse management system (WMS) 103, a warehouse execution system (WES) 104, and a supply chain management system 105. As illustrated in FIG. 1, the control of automated equipment in the warehouse may be controlled in conjunction with or cooperation with an AMR robot controls system (RCS) 107. An exemplary warehouse control system 101 and/or the fulfillment control and monitoring system 102, the warehouse management system 103, the warehouse execution system 104, and the supply chain management system 105 may comprise one or more computer systems or each include respective computer systems or networked servers interoperating with control software. The warehouse control system 101 and its combination of subsystems and/or interconnected systems (102, 103, 104, and 105) are each configured and operable to access the control software to perform the methods and processes for the order fulfillment activities described herein. FIG. 2 illustrates an exemplary warehouse or storage facility 200 for order fulfillment, which is disclosed for use with control systems, e.g., the order fulfillment system 100 and associated warehouse control system 101, in accordance with aspects of the present invention. An exemplary warehouse environment 200 includes a variety of different material handling agents or agents 202, 204, 206. Each class of agents has distinct objectives and capabilities. The agents illustrated in FIG. 2 include human pickers 202, as well as various configurations of automated material handling devices including robotic pickers (also referred to as retrieval/putaway autonomous mobile robots (AMRs) (“retrieval/putaway AMRs”) 204, and automated guided vehicles (AGVs) or AMRs configured for transportation (“transport AMRs”) 206, configured to carry items picked by the human pickers 202 and/or the retrieval/putaway AMRs pickers 204. In one or more implementations, instead of AMR, AGV, or human pickers, alternative automated material handling devices may be used to perform similar operations, such as humanoids or quadrupeds. The overall logistics of the warehouse 200 would be distributed across the classes of agents 202, 204, 206. Additional agents would include fixed automation assets in the warehouse 200 as well as fulfillment management systems (e.g., WES, WCS, and WMS). The agents 202, 204, 206 are allocated and/or assigned to one or more order channels within the warehouse 200, which are managed by the order fulfillment system 100 and the warehouse control system 101. As discussed herein, the order-fulfillment system 100, the warehouse control system 101, and the order-fulfillment control and monitoring system 102 will adjust the order fulfillment activities in the warehouse 200 to optimize pre-sorting activities for each order before sorting the associated inventory items at a unit sortation field selected from a plurality of unit sortation fields. As described herein, by implementing the process steps illustrated in FIGS. 5A, 5B, 6, 7, and 8, it is possible to presort the inventory items (before unit sorting) without having to utilize conventional methods of pre-sorting, e.g., manual pre-sorting and/or the use of a GTP station, and thereby reducing labor and cycling time.

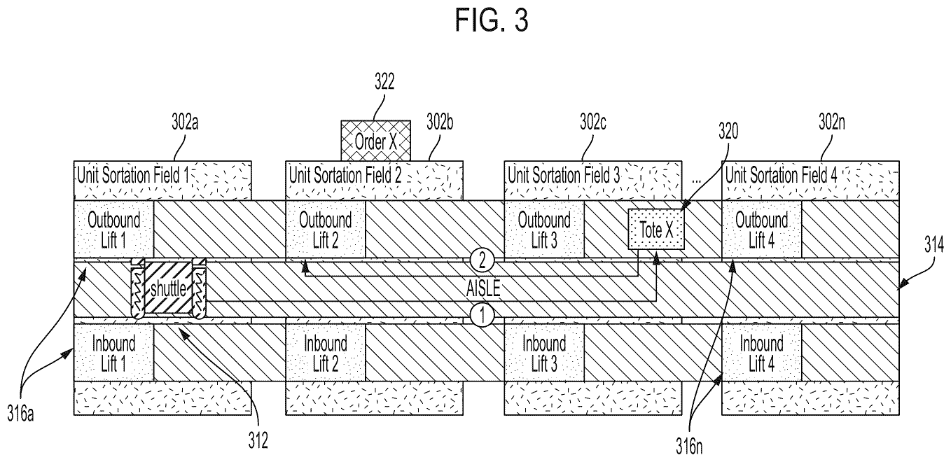

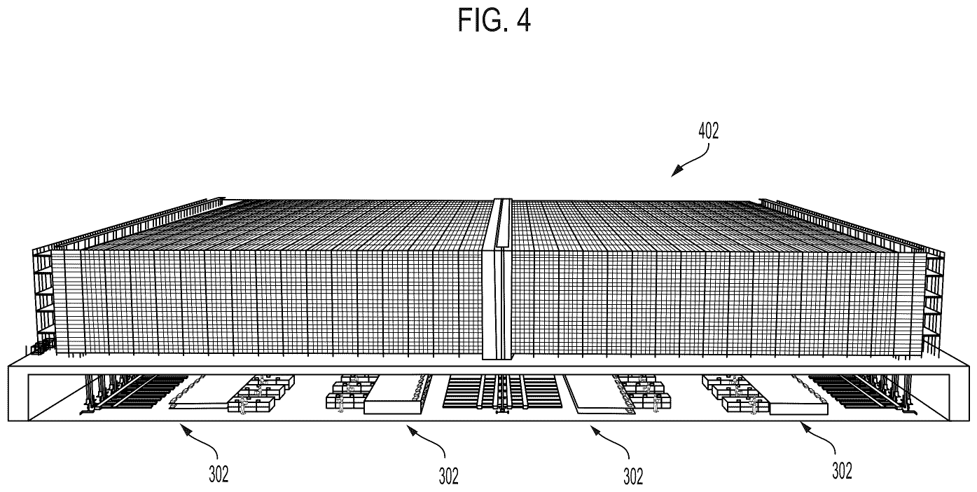

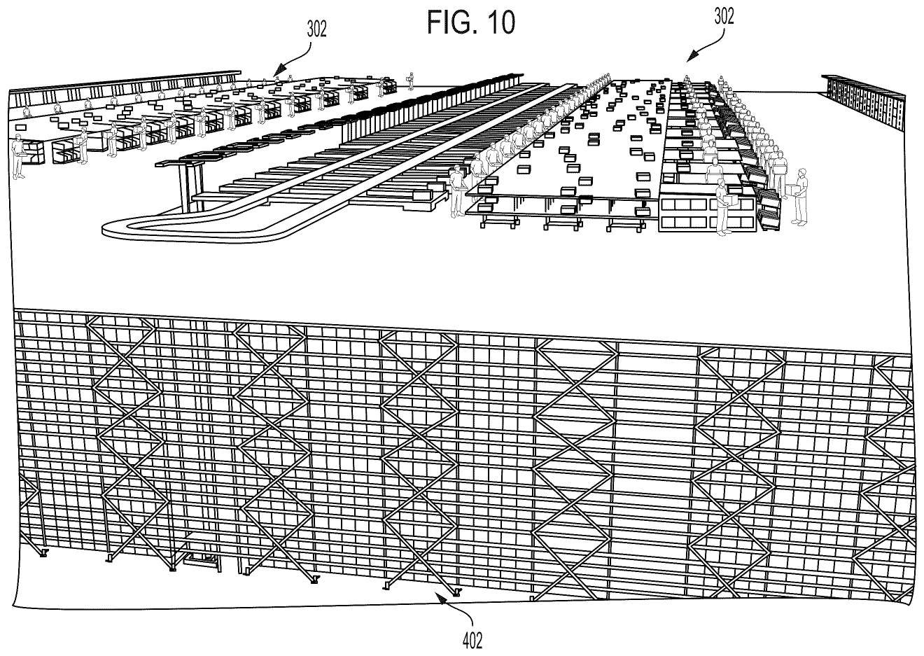

Referring to FIGS. 3, 4, and 10, exemplary unit sortation modules or fields 302 (whether AMR based, cross-belt, or GTP, etc.) are placed atop, below, or in-between aisle levels of an automated storage and retrieval system (ASRS) 402. For example, FIG. 4 illustrates an arrangement of unit sortation fields 302 below the ASRS 402, while FIG. 10 illustrates the unit sortation fields 302 arranged above the ASRS 402. Each level of an exemplary shuttle-based system can contain one or more shuttles 312 per level to meet the required system throughput. Note that each level also includes lifts 316a-316n. As illustrated in FIG. 3, the shuttles 312 are able to retrieve totes 320 and deliver them via the lifts 316a-316n to the desired unit sortation field 302a-302n. Such totes 320 may be referred herein as “donor totes” or “inventory totes.” As also illustrated in FIG. 3, each unit sortation field 302a-302n includes multiple sets of lifts 316a-316n per aisle 314 (e.g., each unit sortation field 302a-302n includes multiple lifts 316a-316n (e.g., outbound and inbound lifts 316a-316n). Thus, each unit sortation field 302a-302n is configured to connect to drop stations of the lifts 316a-316n servicing that unit sortation field 302a-302n. The lift 316a-316n transports the donor tote 320 to the platform of the unit sortation field 302a-302n and the donor tote 320 is transported on, for example, a conveyor running parallel to the shuttle aisles 314, which gives every lift 316a-316n access to the induction station closest to the aisle 314. Thus, rather than needing traditional pre-sorting, the donor totes 320 are retrieved from locations within the ASRS 402 and are sent directly to the required induction station for that order. As described herein, the exemplary sortation system also includes a coexisting GTP station or module(s) to top off the sortable portion with inventory items that are non-sortable, such as, fragile products, round products, too large products, and products with odd or non-uniform geometry, such as non-cuboid geometries, etc.

The donor totes 320 for an entire order are retrieved from their locations with the ASRS 402 and transported directly to the induction station where the inventory items 320 are needed using the shuttles 312 (of the shuttle-based system) and the lifts 316a-316n connected to each aisle 314. Therefore, the donor totes 320 can go from any aisle 314 or location in the ASRS 402 to the induction station and then to any order tote 322 using the unit sortation system (comprising a plurality of unit sortation fields 302a-302n). The shuttle 312 (or controlling shuttle system) selects the lift 316 that corresponds to the unit sortation field 302 where the SKU is located. For example, as illustrated in FIG. 3, the shuttle 312 travels down the aisle 314 to the third unit sortation field 302c, where a donor tote 320 is picked up and using the “outbound” of the lifts 316a-316n of the second unit sortation field 302b, the shuttle 312 delivers the donor tote 320 to the order tote 322.

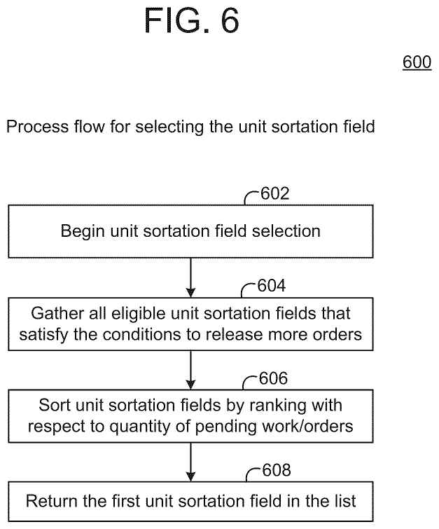

Referring to FIGS. 5A and 5B, an exemplary pre-sorting method 500 provides an exemplary pre-sorting process of an order to a unit sortation field 302 that is triggered by an order release mechanism. Once the order release process has been triggered, a unit sortation field 302 is selected (e.g., any one of unit sortation fields 302a-302n) based upon the pre-sorting method 500. Given the selected unit sortation field 302, an optimized set of order(s) are selected to be released in this field 302 (see method 600, illustrated in FIG. 6). As a result of these two processes (methods 500, 600), the unit sortation field 302 and the set of orders to release in this field 302 are determined. For each order in this set, pre-sorting mechanisms execute the following steps:

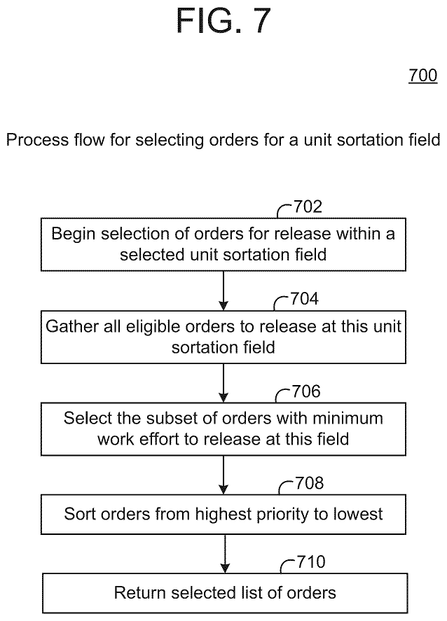

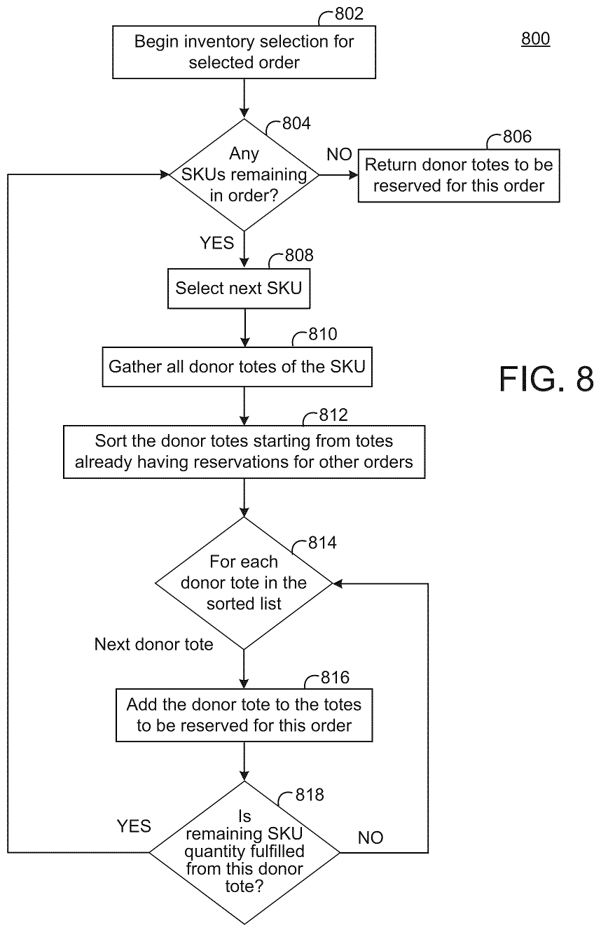

Firstly, order lines which will be processed using sortation (a sortable portion of the order) are activated and inventory is hard allocated for these order lines. Inventory selection should be optimized to maximize the units picked out of one donor tote retrieval (see method 700, illustrated in FIG. 7). The selected inventory is reserved and assigned release sequence numbers. For each reserved inventory tote (i.e., donor tote 320) for the order, the associated storage location and corresponding shuttle 312 are detected. Retrieval tasks for each donor tote 320 is transmitted to the shuttle 312 based on an optimization algorithm (i.e., method 800, illustrated in FIG. 8).

Next, the shuttle 312 retrieves the donor tote 320 horizontally to the rack out of the lift which is connected to the assigned unit sortation field (e.g., 302a-302n). Then a lift 316 transports the donor tote 320 vertically to the level where induct stations are located. This is the last step to pre-sort the donor tote 320 to the assigned unit sortation field 302. Once all donor totes 320 to this order are pre-sorted to the assigned unit sortation field 302a-302n, the order completes the pre-sortation process.

Referring to FIGS. 5A, 5B, 6, 7, 8, and 9 an exemplary sortation process includes an allocation of orders optimized using multiple optimization algorithms (or processes) that dictates the pre-sorting process. As illustrated in FIGS. 5A, 5B, 6, 7, 8, and 9 multiple algorithms, flow diagrams, or processes are needed within the order release solution. Referring to FIGS. 5A and 5B, an exemplary process 500 for managing the sortation of orders is illustrated. In step 502 of FIG. 5A, an order release process is initiated or triggered. In step 504 of FIG. 5A, a unit sortation field is selected for releasing the next order(s). The selection of an optimal unit sortation field into which orders are released is illustrated in FIG. 6. A goal of the process is to balance the workload across multiple unit sortation fields (see FIG. 3). In step 506 of FIG. 5A, order(s) are selected for release into the selected unit sortation field. A process flow for the selection of orders for a particular unit sortation field is illustrated in FIG. 7. In step 508 of FIG. 5A, pre-sorting of the selected order is started. In step 510 of FIG. 5A, sortable portions of the order are activated. In step 512 of FIG. 5A, inventory is selected for hard allocation to this order. An exemplary process for selecting inventory for this order is illustrated in FIG. 8. In step 514 of FIG. 5A, reservations are made from the selected donor totes for this order and release sequence numbers are assigned to the order and the associated donor totes.

The process continues to step 516 of FIG. 5B, where a donor tote is selected with reservations for the order. In step 518 of FIG. 5B, the location of the donor tote is determined. Such location includes the specific aisle and level for the donor tote. With the location of the donor tote determined, a corresponding shuttle is also determined. In step 520 of FIG. 5B, a retrieval task is transmitted to the shuttle. In step 522 of FIG. 5B, the shuttle retrieves the donor tote to the corresponding lift of the unit sortation field. In step 524 of FIG. 5B, the lift transports the donor tote vertically to the induction station level. In step 526 of FIG. 5B, a determination is made as to whether all donor totes of this order have been pre-sorted to the assigned unit sortation field. If there are more donor totes for this order, the process continues to step 528 of FIG. 5B and the next donor tote is pre-sorted and the process returns to step 516 of FIG. 5B for the selection of the next donor tote. If there are no more donor totes for this order, the process continues to step 530 of FIG. 5B where a determination is made as to whether there are more orders in the list to be pre-sorted. If there are more orders in the list to be pre-sorted, the process continues to step 532 of FIG. 5B and the next order for pre-sorting is selected and the process returns to step 508 of FIG. 5A to start pre-sorting the next selected order. If there are no more orders in the list to be pre-sorted, the pre-sorting process 500 concludes in step 534 of FIG. 5B.

Referring to FIG. 6, an exemplary field selection process 600 for selecting a unit sortation field 302 from among a plurality of unit sortation fields 302 is illustrated. The field selection process 600 determines which of the available unit sortation fields 302 a set of orders are to be released in. The field selection process 600 balances the workload across the multiple unit sortation fields 302. In one exemplary embodiment, the field selection process 600 is a heuristic algorithm and uses the following inputs: a maximum work in progress threshold for each unit sortation field 302 (i.e., could be expressed as a quantity of open orders); the number of available order consolidation totes for each unit sortation field 302; the number of pending donor tote retrievals for each unit sortation field 302; the number of pending sortation items for each unit sortation field 302; a shuttle and lift utilization in the automated retrieval and storage system (AS/RS) 402; and sortation equipment utilization for each unit sortation field 302.

In step 602 of FIG. 6, the selection of a unit sortation field is initiated or begun by receiving the above described inputs to evaluate each of the unit sortation fields. In step 604 of FIG. 6, all unit sortation fields 302 that are eligible for the release of new orders are identified. For each unit sortation field 302, there could be a maximum threshold workload determining whether a particular unit sortation field 302 is eligible to release more order into or not. This threshold can be based upon a work-in-progress (WIP)-based system or by a number of available order consolidation totes in that unit sortation field 302 (i.e., a combination of the maximum WIP threshold for each unit sortation field 302 and the number of available order consolidation totes for each unit sortation field 302). Given all eligible unit sortation fields 302, the field selection process 600, in step 606 of FIG. 6, will select the unit sortation field 302 with the least amount of pending workload according to a ranking of unit sortation fields 302 with respect to their respective quantities of pending work/orders. Pending workload can be measured by the number of pending donor tote retrievals and/or the number of pending sortation items in this unit sortation field 302 depending on the current system bottleneck. A “current system bottleneck” will be calculated based on utilization levels in AS/RS 402 and unit sortation fields 302 (i.e., the shuttle and lift utilization in the automated retrieval and storage system (AS/RS) 402 and the sortation equipment utilization for each unit sortation field 302).

For the output, in step 608 of FIG. 6, the field selection process 600 selects a unit sortation field 302 to release new orders in. The next step (in the over-all pre-sorting solution) would be to perform an order selection process 700 for selecting orders for the selected unit sortation field 302, given the selected unit sortation field 302. As a data-driven improvement to the field selection process 600, learning mode methods, such as, artificial intelligence (AI) learning, machine learning (ML), deep learning, quantum learning, and quantum machine learning methods, and the like, could be used to predict pending workload for each unit sortation field 302. In that case, a supervised learning algorithm such as random forest or boosted tree could be used to estimate total workload in hours to complete all pending orders in a unit sortation field 302. The training data should include information about the completion steps and time effort required at each step for historical orders. In another example, one or more learning algorithms, such as a hybrid learning algorithm, may be utilized to further optimize the process, including a balancing of the workload in an extremely short cycle time.

Referring to FIG. 7, the steps to an order selection process 700 are illustrated for finding order(s) to activate within a specified (or selected) unit sortation field 302. The objective of this order selection process 700 is to release similar orders within the same unit sortation field 302 so that the units picked per donor tote retrieval can be maximized, and the quantity of required retrieved donor totes could be minimized under a constraint. For example, example constraints could include a requirement to fulfill orders within their shipment date and urgency requirements.

Similar to the field selection process 600 for the selection of unit sortation fields 302, an exemplary embodiment of the order selection process 700 also uses a heuristic algorithm for the selection of orders for the selected unit sortation field 302, includes a variety of inputs. Such inputs include all available and not released orders (those not assigned to a unit sortation field); all active orders already released in this selected unit sortation field 302; all active orders already assigned and released in other unit sortation fields 302; information about not released and already released orders (i.e., SKUs, quantity demanded, urgency, shipment date, and donor totes en route for already released orders); and quantity of orders to release at this attempt in this unit sortation field 302 (or release until the maximum threshold WIP workload has been reached, which is defined as discussed herein. The order selection process 700 utilizes four main criteria to filter and rank the orders: (1) urgency of the order, (2) SKU similarity (affinity) of the order to the active orders in the selected unit sortation field 302, (3) SKU dissimilarity of the order to the active orders in other (unselected) unit sortation fields 302, and (4) SKU dissimilarity of the order to other not released and assigned orders.

As illustrated in FIG. 7, a first step is to review the available and not yet released orders and to filter out those orders which have the earliest shipment date (and highest priority) to consider the most urgent orders first. The resulting list of orders with highest priority (according to shipment date) is then reviewed and ranked. In one embodiment, such ranking can include a ranking system. An exemplary ranking system uses SKU affinity or similarity. In one embodiment, SKU similarity is found using an exemplary heuristic process by counting unique instances of SKUs that are the same or by using machine learning processes, such as clustering. A SKU similarity of each order in the list of orders is assessed with respect to the active orders in the selected unit sortation field 302. In addition to SKU similarity, the ranking system also includes a consideration of SKU dissimilarity of each of the orders in the list of orders with respect to the active orders in the remaining unit sortation fields 302 and the SKU dissimilarity of each of the orders in the list of orders to other not yet released and assigned orders. Based on SKU similarity between each order in the list of orders and the already active orders in the selected unit sortation field 302, those orders with the highest SKU affinity (or similarity) to the already active orders in the selected unit sortation field 302 can be ranked at the top of the list of orders. Then, a second round of ranking of the list of orders can be performed to rank those orders according to their lack of affinity (or dissimilarity) to the active orders in the other unit sortation fields 302. Lastly, those orders in the list of orders with the lowest SKU affinity to the other not yet released and assigned orders are filtered. Such filtering can allow for the identification and removal of those orders in the list of orders that are most dissimilar to the other orders in the list of orders. Thus, a filtered and ranked list of orders for assignment to the selected unit sortation field 302 is identified.

Thus, in step 702 of FIG. 7, the selection of orders for release within a selected unit sortation field 302 (e.g., FIG. 3 at 302b, Unit Sortation Field 2) is begun. In step 704 of FIG. 7, all eligible orders are identified that could be selected for release within the selected unit sortation field 302. Eligible orders include those orders that have not yet been released to a unit sortation field 302. Eligible orders also include those as defined by customer rules. For example, some unit sortation fields 302 are only able to process certain order types. Thus, order eligibility will entail any rules about what orders can be released to the selected unit sortation field 302. In step 706 of FIG. 7, the eligible orders are reviewed to identify a subset of the gathered eligible orders. The subset of eligible orders for release to the selected unit sortation field 302 is based upon the ranking(s) of the eligible orders, as discussed herein. In step 708 of FIG. 7, the orders within the subset of eligible units are sorted according to priority (from highest priority to lowest priority). In step 710 of FIG. 7, the ranked list of eligible units is returned.

With a ranked list of eligible orders selected (by the order selection process 700) for the selected unit sortation field 302 (as selected by the field selection process 600), as illustrated in FIG. 8, inventory for each of the selected orders is selected by an inventory selection process 800. As described herein, the inventory selection process 800 selected a “best” or “preferred” inventory for fulfilling an order. For example, a same inventory item needed to fulfill a selected order can be located in multiple locations in the ASRS 402 (i.e., to avoid the bottleneck effect). In one embodiment, an objective of the inventory selection process 800 is to reuse currently active donor totes (i.e., those donor totes already reserved for an order and still en route to an induct station). In one embodiment, the inventory selection process 800 utilizes a heuristic algorithm with the following inputs: (1) information about each selected order (e.g., inventory item SKUs, quantity demanded), (2) list of all donor totes in the system for each SKU in each of the selected orders, (3) lists of currently active and en route donor totes for each SKU in each of the selected orders, and (4) rules for breaking ties when selecting the inventory items, such as, “pick to deplete,” first-in, first-out (FIFO), last-in, first-out (LIFO). For each inventory item SKU in a selected order, the inventory selection process 800 starts allocating the demanded quantity to the currently active and en route donor totes of the same SKU. If currently active and en route donor totes cannot be used to fulfill all of the quantity of the SKU (of the current selected order), the remaining quantity of inventory items is assigned to the non-reserved donor totes. The resulting output of the inventory selection process 800 is the list of donor totes with reserved SKUs and quantities for the selected order.

Thus, in step 802 of FIG. 8, the process for selecting inventory for a selected order is begun. In step 804 of FIG. 8, a determination is made as to whether there are any remaining inventory item SKUs to be allocated for a selected order. Obviously, when the inventory selection process 800 begins, the answer will be “YES,” but as the process loops through a few times, the allocation of inventory item SKUs will be completed, and the process will continue to step 806 of FIG. 8 and the selected donor totes (for each inventory item SKU) are reserved for the selected order. Otherwise (i.e., there are still unallocated inventory item SKUs remaining), the inventory selection process 800 continues to step 808 of FIG. 8 and a next inventory item SKU (needed for order fulfillment) is selected. In step 810 of FIG. 8, all donor totes that contain the needed inventory item SKU are identified.

In step 812 of FIG. 8, the identified donor totes with the needed inventory item SKU are sorted. Such sorting starts with sorting out the donor totes already having reservations for other orders. Thus, currently active donor totes (those reserved for an order and en route to an induct station) can be reused to meet at least part of the inventory quantity allocation for fulfillment of the selected order. Once the identified donor totes have been sorted, the inventory selection process 800 continues to step 814 of FIG. 8 where during a loop, the individual donor totes of the sorted list are reserved for the selected order. In particular, in step 814 of FIG. 8, for each donor tote in the sorted list, in step 816 of FIG. 8, for the next donor tote, the donor tote is added to the list of donor totes to be reserved for this selected order. In step 818 of FIG. 8, a determination is made as to whether the remaining inventory item SKU quantity required for fulfillment is available from this donor tote. If the remaining quantity of the inventory item SKU is available in the current donor tote, the process continues back to step 804 to determine if there are any remaining SKUs in the order. If there is a remaining quantity of the current inventory item SKU, the process 800 returns back to step 814 and a next donor tote from the sorted list is selected for fulfillment. Thus, a selection of donor totes from the sorted list of donor totes (for each SKU) is reserved for fulfillment of the selected order.

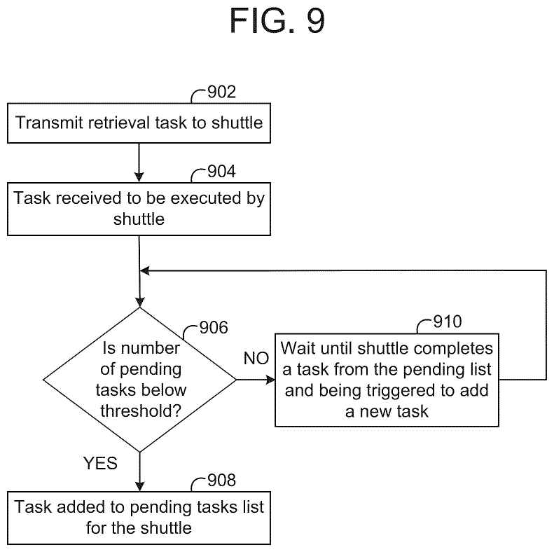

Referring to FIG. 9, the assignment of missions to shuttles 312 is managed. Once the inventory has been allocated and the donor tote(s) selected for a selected order, a shuttle management process 900 determines when to assign a retrieval mission to a shuttle 312 carrying the selected tote(s). An exemplary objective of the shuttle management process 900 is to feed the shuttle 312 with enough work (e.g., retrieval missions) to prevent the shuttle 312 from being starved, while not pre-committing the shuttle 312 to too many missions. Pre-committing the shuttle 312 to too many missions might block the order fulfillment system from assigning higher-priority tasks as they drop to the system. Similar to the other processes discussed herein, in an exemplary embodiment, the shuttle management process 900 includes a heuristic algorithm with the following inputs: (1) a maximum threshold for pending donor tote retrievals for the shuttle 312, and (2) a list of current pending donor tote retrievals for the shuttle 312.

Once a retrieval task has been triggered for appending to the shuttle pending list of retrieval tasks, the shuttle management process 900 will check whether the quantity of pending donor tote retrievals is below a maximum threshold. The retrieval task will be added to the pending list of retrieval tasks once this condition is satisfied. An exemplary output of the shuttle management process 900 will output an indication of when to add the next retrieval task to the shuttle's pending list.

Thus, in step 902 of FIG. 9, a next retrieval task is transmitted to a shuttle 312. In step 904 of FIG. 9, the shuttle receives the retrieval task. In step 906 of FIG. 9, it is determined whether the quantity of pending tasks for the shuttle 312 is below a task threshold. If the quantity of pending tasks is below the threshold, the process 900 continues on to step 908 of FIG. 9 and the next retrieval task is added to a list of pending tasks for the shuttle 312. If the quantity of pending tasks is above the threshold, the process 900 waits until a shuttle 312 completes a task from the pending list and is triggered to add a new task.

The multi-objective optimization of the methods 500, 600, 700, 800 may include any one or more of the following optimizations:
Minimizing late orders (completed after their cut-off time).
Maximizing processed orders.
Maximizing pick batch factors.
Balancing workload across automated storage and retrieval system (ASRS) aisles.
Minimizing tote bottleneck occurrences.
Minimizing travel distance from donor tote rack location to selected lift.
Balancing workload across unit sortation fields.
Maximizing shuttle performance.
Maximizing lift performance.
Minimizing sortation equipment travel distances.
Minimizing order dwell time at post-sorting consolidation points.
Balancing workload across order consolidation areas.
Having a packing station mix that matches the current orders processed.
   The relative “weight” of these objectives in the multi-objective function is project dependent and can change over time based on current conditions of the system. Additional benefits of the present embodiments include solving the limited throughput of a conventional unit sortation module. The exemplary embodiments are modular and easily scales to 50,000 units per hour without impact on performance. The embodiments handles non-sortable items in a GTP-based module. The embodiments require no manual labor for pre-sorting. The cycle time is reduced. Lastly, going vertical, the required footprint for the fulfillment system is reduced.

Thus, the illustrative and exemplary embodiments of the present invention provide methods and a fulfillment system in which the inventory items for an order are presorted as part of the process for delivering them to a unit sortation field for order fulfillment. An exemplary pre-sorting process (before delivery to a unit sortation field) is used with an order fulfillment system with multiple unit sortation fields. A first step in the process is a selection of a particular unit sortation field out of the plurality of available unit sortation fields. With the selection of a unit sortation field, the allocation of orders is optimized with respect to the selected unit sortation field. Additionally, based upon the selected orders (optimized for the selected unit sortation field), optimized donor totes (with the requested inventory item SKUs for order fulfillment) are selected with respect to the selected orders and the selected unit sortation field. Lastly, the operation of the shuttles within an automated storage and retrieval system (ASRS) is coordinated such that the shuttle retrieval and delivery of selected donor totes is optimized for the selected order and the selected united sortation field.

As previously described, a computer system described with reference to the figures herein may generally comprise a processor, an input device coupled to the processor, an output device coupled to the processor, and memory devices each coupled to the processor. The processor may perform computations and control the functions of the system, including executing instructions included in computer code for the tools and programs capable of implementing methods for monitoring warehouses, distribution centers, and intralogistics, in accordance with some embodiments. The instructions of the computer code may be executed by the processor via a memory device. The computer code may include software or program instructions that may implement one or more algorithms for implementing one or more of the foregoing methods. The processor executes the computer code.

The onboard computer, a processor integrated into the RCS, or a virtual processor formed as a portion of the WES, can be any processor such as a digital signal processor (DSP), a general purpose core processor, a graphical processing unit (GPU), a computer processing unit (CPU), a microprocessor, an AI processing unit, a crypto-processor unit, a neural processing unit, a silicon-on-chip, a graphene-on-chip, a neural network-on-chip, a neuromorphic chip (NeuRRAM), a system on a chip (SoC), a system-in-package (SIP) configuration, either single-core or multi-core processor, or any suitable combination of components, and the like.

The memory device may include input data. The input data may include any inputs required by the computer code. The output device displays output from the computer code. A memory device may be used as a computer usable storage medium (or program storage device) having a computer-readable program embodied therein and/or having other data stored therein, and with the computer-readable program including the computer code. Generally, a computer program product (or, alternatively, an article of manufacture) of the computer system may comprise the computer usable storage medium (or the program storage device).

As will be appreciated by one skilled in the art, an exemplary embodiment may be a computer program product. Any of the components of the exemplary embodiments can be deployed, managed, serviced, etc. by a service provider that offers to deploy or integrate computing infrastructure with respect to embodiments of the present disclosure. Thus, an embodiment of the disclosure discloses a process for supporting computer infrastructure, where the process includes providing at least one support service for at least one of integrating, hosting, maintaining and deploying computer-readable code (e.g., program code) in a computer system including one or more processor(s). The processor(s) carry out instructions contained in the computer code, such that the computer system generates a technique described with respect to the embodiments described herein. In another embodiment, an exemplary process supports computer infrastructure, where the process includes integrating computer-readable program code into a computer system including a processor.

Aspects of the disclosures are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible exemplary implementations of systems, methods, and computer program products according to various embodiments of the disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Changes and modifications in the specifically described embodiments can be carried out without departing from the principles of the present invention, which is intended to be limited only by the scope of the appended claims, as interpreted according to the principles of patent law including the doctrine of equivalents.

1. A material handling system for retrieving, transporting, and delivering inventory totes for order fulfillment activities within a material handling facility, the material handling system comprising:
a plurality of unit sortation fields arranged within the material handling facility, each configured for sorting operations of inventory items for order fulfillment activities, wherein selected inventory items are required by an associated order;
a storage area configured for storing inventory totes, each comprising one or more associated inventory items;
a shuttle system comprising a plurality of shuttles, each shuttle configured to retrieve an inventory tote from the storage area for delivery to a selected unit sortation field of the plurality of unit sortation fields; and
a control system for controlling the order fulfillment activities within the material handling facility;
wherein the control system is operable to select a unit sortation field from the plurality of unit sortation fields based upon the order fulfillment operations underway within ones of the plurality of unit sortation fields.

2. The material handling system of claim 1, wherein the control system is operable to select a unit sortation field from the plurality of unit sortation fields based upon at least one of: a quantity of consolidation totes for each unit sortation field, quantity of pending inventory tote retrievals for each unit sortation field, shuttle and storage area utilization, and sortation equipment utilization for each unit sortation field of the plurality of unit sortation fields.

3. The material handling system of claim 1, wherein the control system is operable select an order from a list of orders awaiting order fulfillment for the selected unit sortation field.

4. The material handling system of claim 3, wherein the control system is operable to select an order from the list of orders based upon a priority ranking of the selected order with respect to ones of the plurality of orders.

5. The material handling system of claim 3, wherein the control system is operable to generate the list of orders based upon a selection of orders ready for release within the selected unit sortation field.

6. The material handling system of claim 3, wherein the control system is operable to select an order from the list of orders based upon the similarity or dissimilarity of inventory items requested by orders as compared to inventory items requested by orders already released to the selected unit sortation field.

7. The material handling system of claim 3, wherein the control system is operable to select inventory items for order fulfillment requested by the selected order, wherein the control system is operable to select an inventory tote within the storage area containing the requested inventory item.

8. The material handling system of claim 7, wherein the control system is operable to select a first inventory tote containing the requested inventory item from a plurality of inventory totes each containing the requested inventory item, wherein the control system is operable to select the first inventory tote based upon its location within the storage area.

9. The material handling system of claim 8, wherein the control system is operable to send a retrieval task to a first shuttle of the plurality of shuttles to retrieve the first inventory tote for delivery to the selected unit sortation field.

10. The material handling system of claim 9, wherein each unit sortation field of the plurality of unit sortation fields comprises at least one inbound lift and at least one outbound lift for transporting shuttles of the plurality of shuttles between levels of the storage area, such that the first shuttle is able to retrieve the first inventory tote from anywhere within the storage area and delivery the requested inventory tote to the selected unit sortation field.

11. The material handling system of claim 1, wherein the storage area is an automated storage and retrieval system, and wherein the plurality of unit sortation fields are arranged with respect to the automated storage and retrieval system.

12. A method of order fulfillment for retrieving, transporting, and delivering inventory totes for order fulfillment activities within a material handling facility with a plurality of unit sortation fields, the method comprising:
selecting a first unit sortation field from a plurality of unit sortation fields;
selecting a first order from a plurality of orders for release into the first unit sortation field;
selecting inventory totes containing inventory items required for fulfillment of the first order, wherein the inventory totes are stored in a storage area, wherein selecting inventory totes comprises reserving selected inventory totes from a plurality of inventory totes for the first order and assigning release sequences for the selected inventory totes;
determining a location of a first inventory tote of the selected inventory totes and assigning a first shuttle of a plurality of shuttles for retrieving the first inventory tote; and
retrieving, with the first shuttle, the first inventory tote and delivering the first inventory tote to the first unit sortation field.

13. The method of claim 12, wherein selecting a unit sortation field from the plurality of unit sortation fields is based upon the order fulfillment operations underway within ones of the plurality of unit sortation fields.

14. The method of claim 13, wherein selecting a unit sortation field from a plurality of unit sortation field is further based on at least one of: a quantity of consolidation totes for each unit sortation field, quantity of pending inventory tote retrievals for each unit sortation field, shuttle and storage area utilization, and sortation equipment utilization for each unit sortation field of the plurality of unit sortation fields.

15. The method of claim 12, wherein selecting an order from the plurality of orders is based upon a priority ranking of the selected order with respect to ones of the plurality of orders.

16. The method of claim 15, wherein selecting the order is based upon a selection of orders ready for release within the selected unit sortation field.

17. The method of claim 15, wherein selecting the order is based upon similarities or dissimilarities of inventory items requested by orders as compared to inventory items requested by orders already released to the selected unit sortation field.

18. The method of claim 12, wherein selecting inventory totes from a plurality of inventory totes is based upon the locations of ones of the inventory totes.

19. The method of claim 12, wherein each unit sortation field of the plurality of unit sortation fields comprises at least one inbound lift and at least one outbound lift for transporting shuttles between levels of the storage area.

20. The method of claim 12, wherein the storage area is an automated storage and retrieval system, and wherein the plurality of unit sortation fields are arranged with respect to the automated storage and retrieval system.
